(19) United States
(12) Patent Application Publication
(10) Pub. No.: US 2014/0268725 A1
(43) Pub. Date: Sep. 18, 2014

(54) SYSTEM FOR THE DISTRIBUTION OF LUMINANCE

(71) Applicants: Scott S. YU, Mil Valley, CA (US); Tom WARTON, Sonoma, CA (US)

(72) Inventors: Scott S. YU, Mil Valley, CA (US); Tom WARTON, Sonoma, CA (US)

(21) Appl. No.: 14/208,680

(22) Filed: Mar. 13, 2014

Related U.S. Application Data
(60) Provisional application No. 61/801,860, filed on Mar. 15, 2013.

(51) Int. Cl. F21V 14/08

(52) U.S. Cl. CPC F21V 14/08
USPC 362/220; 362/283

(57) ABSTRACT

A luminaire including a rectangular housing for housing a light source. The housing has an elongated opening for projecting the light and shutters positioned across the opening to control the light emerging from the light source through the opening. The shutters are pivotably mounted about the opening and a worm-drive is provided for setting the positions of the shutters which in-turn affects the output beam angle of the luminaire.

### PRIORITY

This application claims the benefit of co-pending provisional patent application 61/801,860 filed Mar. 15, 2013 entitled “A System For The Distribution Of Luminance” by the same inventors which is incorporated by reference as if fully set forth herein.

### BACKGROUND

The present invention relates generally to a luminaire and more particularly to a modular lighting system, which comprises a plurality of lighting system components, which can be designed in a variety of different ways. With even more particularity to the modification of the distribution of light.

Lighting fixtures are one of the basic lighting devices used in homes, offices and a variety of industrial settings. A typical lighting fixture may be mounted on a wall, at a position above a desk, in a corridor, a door entrance, or a garage door such that the lighting fixture can illuminate the area. There are many factors that control the market for luminaires and lighting systems. A few important factors are the ability to create a well-lit hospitable environment, cost efficiency such as operating cost and other associated costs, code compliance, and more particularly aesthetics. One task that lighting designers have is finding adjustable illumination in accordance with an architectural design. Traditional luminaires when mounted include housing, lamps, circuit boards, connectors, lens and other components. This can create an aesthetics or size constraint issue because of the large size of the luminaires. Additionally lighting designers have the task of positioning luminaires at the correct angle to better illuminate the environment. Typically after mounting a traditional luminaires, the distribution of light is set and cannot or can only be minimally be modified. What is needed to make the environment more aesthetically pleasing is an easy to install, affordable means for attaching a lighting system to a support structure and for modifying the distribution of light after installation.

### SUMMARY

Disclosed herein is a device including a rectangular housing for housing a light source. The housing has an elongated opening for projecting the light and shutters positioned across the opening to control the light emerging from the light source through the opening. The shutters are pivotably mounted about the opening and a worm-drive is provided for setting the positions of the shutters which in-turn affects the output beam angle of the luminaire.

The housings may be formed in a variety of shapes and the shutters may be effectuated using material with different optical properties. In operation, the light source, the position of the shutters and shutter material operate to create adjustable lighting systems.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 depicts one embodiment of an adjustable lighting fixture.

FIG. 2 shows an illustration of a worm drive.

### DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Read this application with the following terms and phrases in their most general form. The general meaning of each of these terms or phrases is illustrative, not in any way limiting.

### Lexicography

The term “luminaire” generally refers to a lighting unit consisting of a light source such as an light emitting diode (LED) or lamp(s) together with the parts designed to distribute the light, to position and protect the light source and to connect the light source to a power supply.

The term “luminance” generally refers to the brightness of a light source or an object that has been illuminated by a source.

### DETAILED DESCRIPTION

FIG. 1 depicts one embodiment of an adjustable lighting fixture 100. The lighting fixture 100 has a housing 110, which provides a physical support structure for accommodating luminaire components. The luminaire components may be inside the housing 110 such that the housing 110 encloses at least a portion of the luminaire components such as the light sources such as lamps and LEDs along with control circuits to operate those light sources. The light source is positioned to provide light out of an opening on the housing. The housing may be different shapes to allow for different light effects from the light source and in certain embodiments the opening may be formed to enhance those affects.

Coupled to the housing 110 are two extended members 112 and 114. The extended member 112 and 114 may be optically dark or provide for different degrees of translucency or clarity. The extended members may further include diffraction patterns to modify light passing out of the opening. Each of the extended members 112 and 114 each can be rotated about a pivot axis 113 and 115 located along each extended member. The pivot axis may be effectuated using a pin or swivel mechanism attaching a single point of the extended members 112 and 114 to an opening on the housing 110. The extended members 112 and 114 are sized to fit snugly together when both extended members are rotated closed about the pivot axes (as shown in FIG. 1A). This provides for complete coverage of the lamp and minimal to no light distribution. Additionally, when the extended members 112 and 114 are rotated open about the pivot axes the distribution of light is modified and more light can be dispensed (FIGS. 1B-1C). The output beam angle can also be adjusted by individually rotating or rotating both the extended members 112 and 114.

The extended members 112 and 114 can be adjusted by a mechanism coupled to the extended members 112 and 114 and located on the housing. Alternatively the extended members 112 and 114 can be adjusted remotely. One having skill in the art will recognize that the adjustment may be effectuated using a worm-drive system wherein a worm (a gear in the form of a screw) meshes with a worm gear mounted on each extended member 112 and 114. The worm-drive may be operated using a set screw coupled to the worm-drive or in certain embodiments a motion activator may be coupled to the worm to allow for electronic control of the extended members.

In operation, after the lighting fixture 100 is installed, the distribution of light can be modified by the user either remotely using a remote control or by manually adjusting the extended members 112 and 114 using the mechanism to affect a different output beam angles 116 Thus providing an adjustable lighting fixture, which is easy to install. This embodiment may be made from aluminum or other suitable material. Typical material includes, but is not limited to plastics, metals, ceramics, wood and fiberglass or combination thereof. One having skill in the art will appreciate that results of the lighting fixture may be effectuated using other materials.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

FIG. 2 shows an illustration of a worm drive. In FIG. 2 a housing 210 encloses a first 212 and a second shutter 214. Each shutter includes a gear mechanism 216 and 218, which are each in turn coupled to a worm gear 220. The worm gear 220 includes a head 222, which may be a screw head, for positioning the worm gear and consequently the shutters 212 and 214.

The above illustration provides many different embodiments or embodiments for implementing different features of the invention. Specific embodiments of components and processes are described to help clarify the invention. These are, of course, merely embodiments and are not intended to limit the invention from that described in the claims.

Certain aspects and embodiments of the current disclosure are included in the attached appendix which is incorporated by reference as if fully set forth herein.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

We claim:

1. A device including:
a first panel, said panel rotationally affixed to a housing, and disposed about an opening in the housing;
a second panel, said second panel rotationally affixed to a housing, and disposed about the opening in the housing, and
a drive, said drive operable to rotate at least one of either the first or second panel about a pivot point.

2. The device of claim 1 further including:
a light source, said light source at least partially disposed within said housing,
wherein light from the light source project through the opening.

3. The device of claim 1 wherein either the first and second panel are optically dark.

4. The device of claim 1 wherein the either the first or second panel are translucent.

5. The device of claim 1 wherein the dive is a worm drive having a screw portion and a gear portion attached to at least one of either the first or second panel.

6. The device of claim 1 wherein the housing is substantially rectangular.
